(19) United States
(12) Patent Application Publication
(10) Pub. No.: US 2006/0291721 A1
(43) Pub. Date: Dec. 28, 2006

(54) Efficiently labelling image pixels using graph cuts

(75) Inventors: Philip Hilaire Sean Torr, Oxford (GB); Pushmeet Kohli, Oxford (GB)

Correspondence Address: Eric D. Cohen, 22nd Floor, 120 South Riverside Plaza, Chicago, IL, 60606-3945, US

(73) Assignee: Oxford Brookes University, Oxford (GB)

(21) Appl. No.: 11/471,117

(22) Filed: Jun. 20, 2006

(30) Foreign Application Priority Data
Jun. 23, 2005 (GB) 0512837.6

(51) Int. Cl. G06K 9/34

(52) U.S. Cl. 382/173

(57) ABSTRACT

A method of solving an energy minimization problem, the method comprising: a. constructing a graph representative comprising a set of nodes; two terminals; a set of N-links each connecting a pair of the nodes; and a set of T-links each connecting one of the terminals with one of the nodes; b. assigning a capacity to each of the N-links; c. assigning a capacity to each of the T-links; d. determining a first minimum cut/maximum flow solution which partitions the nodes into subsets, each subset containing one of the terminals; e. changing the capacity assigned to at least one of the N-links and at least one of the T-links in response to a change in the problem; and f. dynamically updating the first minimum cut/maximum flow solution determined in step d. to take into account the changed capacities.

### FIELD OF THE INVENTION

The present invention relates to a method of solving an energy minimization problem, typically (although not exclusively) in order to label image pixels.

### BACKGROUND OF THE INVENTION

1. Introduction

Graph Cuts are being increasingly used in computer vision as an energy minimization technique. One of the primary reasons behind this growing popularity is the availability of numerous algorithms with excellent algorithmic complexity for solving the st-mincut problem [1]. Further, maximum a-posteriori (MAP) estimation of a Markov Random Field (MRF) under the generalized Potts, and linear clique potential models can be performed by using graph cuts [5]. This equivalence between the mincut problem and MAP-MRF estimation makes graph cuts extremely important, especially considering the fact that the probabilistic distributions of interacting labels of many problems such as image segmentation, stereo, image restoration can be modelled using MRFs.

Greig et al. [11] showed that the MAP solution of a two label first order MRF can be solved in polynomial time by finding the st-mincut on the equivalent graph. That result has been extended by [12] for MRFs with multiple labels and convex priors. These are important results considering that the size of the state-space for the labelling problem is exponential in the number of nodes (sites). Furthermore, Boykov et al. [6] have proposed algorithms based on graph cuts which could efficiently find approximate solutions to many different energy functions.

For certain labelling problems, a solution has to be repeatedly computed while the objective function and constraints defining the problem change. For instance, this is the case when image segmentation is performed on the frames of a video where the data (image) in the problem changes from one time instance to the next. In such problems, the MAP solution of the MRF representing the problem at the previous time instant should intuitively be a good initialization for the energy minimization procedure compared to an arbitrary point in the state-space. If the change in the MRF representing the problem instance is minimal from one time instant to the next, such an initialization should substantially speed up the inference process since the number of points having lower energy would be less, which in turn would result in less number of energy decreasing transitions made by the energy minimization procedure. In the context of the st-mincut/max-flow problem, this corresponds to the use of flows obtained in the solution of the previous problem instance, in finding the solution to the next problem instance as seen in FIG. 1.

FIG. 1 shows Segmentation of Images using Graph Cuts. The images in the first column are consecutive frames of a video sequence and their respective segmentations, with the first image showing the user segmentation seeds (which are used as soft constraints on the segmentation). In column 2, we observe the flows obtained corresponding to the MAP solution of the MRF. It can be clearly seen that the flows corresponding to the two segmentations are similar.

Such an algorithm for the maximum flow problem would belong to a broad category of algorithms which are referred to as dynamic. These algorithms solve a problem by dynamically updating the solution of the previous problem instance. Their goal is to be more efficient than recomputing the solution after every change from scratch. Given a directed weighted graph, a fully dynamic algorithm for the minimum cut problem should allow for unrestricted modification of the graph.

Graph Cuts in Computer Vision

The rising interest in the combinatorial min-cut/max-flow algorithm has prompted a more thorough analysis of it's applicability. Kolmogorov et al. [13] defined the set of energy functions which could be minimized using graph cuts by providing certain conditions which should be satisfied by all such functions. A number of papers have also addressed the theoretical properties of graph constructions used in vision. These properties influence the efficiency of algorithms which solve the st-mincut problem. The graphs used in computer vision are generally 2D or 3D grids having a large number of nodes. Boykov et al. [4] proposed a specialized algorithm for finding mincuts, which has been experimentally shown to be faster on graphs typically used in vision applications, compared to other algorithms for the problem.

Overview of Dynamic Graph Cuts

Dynamic algorithms are not new to computer vision. They have been extensively used in computational geometry for problems such as range searching, intersections, point location, convex hull, proximity and many others. For more on dynamic algorithms used in computational geometry, the reader is referred to [7].

A number of algorithms have been proposed for the dynamic generalized mincut problem. Thorup [14] proposed a method which had a O(|E|^{1/2}) update time and took O(log n) time per edge to list the cut edges. However, the dynamic st-mincut problem has remained relatively ignored until recently. Cohen et al. [8] showed how dynamic expression trees can be used for maintaining st-mincuts in series-parallel diagraphs with O(log m) time for update operations. Series-Parallel digraphs are planar, acyclic and connected.

Boykov et al. [3] were the first to use a partially dynamic st-mincut algorithm in a vision application, by proposing a technique by which they could update capacities of certain edges and recompute graph cuts dynamically. They used this method for performing interactive image segmentation, where the user could improve segmentation results by giving additional segmentation cues (seeds) in an online fashion. However, their scheme was restrictive and did not allow for changing the graph completely.

### SUMMARY OF THE INVENTION

A first aspect of the invention provides a method of labelling image pixels, the method comprising:
a. constructing a graph representative of an image, the graph comprising a set of nodes each representative of one of the image pixels; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals;
e. changing the capacity assigned to at least one of the N-links and at least one of the T-links in response to a change in the image; and
f. dynamically updating the first minimum cut/maximum flow solution determined in step d. to take into account the changed capacities.

A second aspect of the invention provides a method of labelling image pixels, the method comprising:
a. constructing a graph representative of an image, the graph comprising a set of nodes each representative of one of the image pixels; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals, the first solution being determined by:
   i. generating a residual graph from the graph, and
   ii. performing an augmenting path algorithm on the residual graph, the augmenting path algorithm generating at least one search tree;
e. changing the capacity assigned to at least one of the N-links or at least one of the T-links in response to a change in the image; and
f. dynamically updating the first minimum cut/maximum flow solution determined in step d. to take into account the changed capacity, the first solution being updated by:
   iii. updating the residual graph generated in step d., and
   iv. performing the augmenting path algorithm on the updated residual graph, the augmenting path algorithm reusing the search tree generated in step dii.

A third aspect of the invention provides a method of solving an energy minimization problem, the method comprising:
a. constructing a graph representative comprising a set of nodes; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals;
e. changing the capacity assigned to at least one of the N-links and at least one of the T-links in response to a change in the problem; and
f. dynamically updating the first minimum cut/maximum flow solution determined in step d. to take into account the changed capacities.

A fourth aspect of the invention provides a method of solving an energy minimization problem, the method comprising:
a. constructing a graph representative comprising a set of nodes; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals, the first solution being determined by:
   i. generating a residual graph from the graph, and
   ii. performing an augmenting path algorithm on the residual graph, the augmenting path algorithm generating at least one search tree;
e. changing the capacity assigned to at least one of the N-links or at least one of the T-links in response to a change in the problem; and
f. dynamically updating the first minimum cut/maximum flow solution determined in step d. to take into account the changed capacity, the first solution being updated by:
   i. updating the residual graph generated in step di., and
   ii. performing the augmenting path algorithm on the updated residual graph, the augmenting path algorithm reusing the search tree generated in step dii.

The methods of the invention may be used in a number of applications, including (but not limited to) interactive image segmentation, video segmentation, 3D reconstruction of objects, fast coarse-to-fine segmentation and reconstruction, and pose inference in motion capture. The methods are also useful in learning the optimal values of different parameters of many computer vision problems such as stereo, segmentation etc.

### BRIEF DESCRIPTION OF THE DRAWINGS

An embodiment of the present invention will now be described with reference to the accompanying drawings, in which:

FIG. 1 shows Segmentation of Images using Graph Cuts.

FIG. 2 is a graph representing an MRF.

FIG. 3 shows Segmentation using User Constraints.

FIG. 4 shows the segmentation results of the human lame walk video sequence.

FIG. 5 shows the number of augmenting paths found by the algorithms.

FIG. 6 shows the running time of the algorithms.

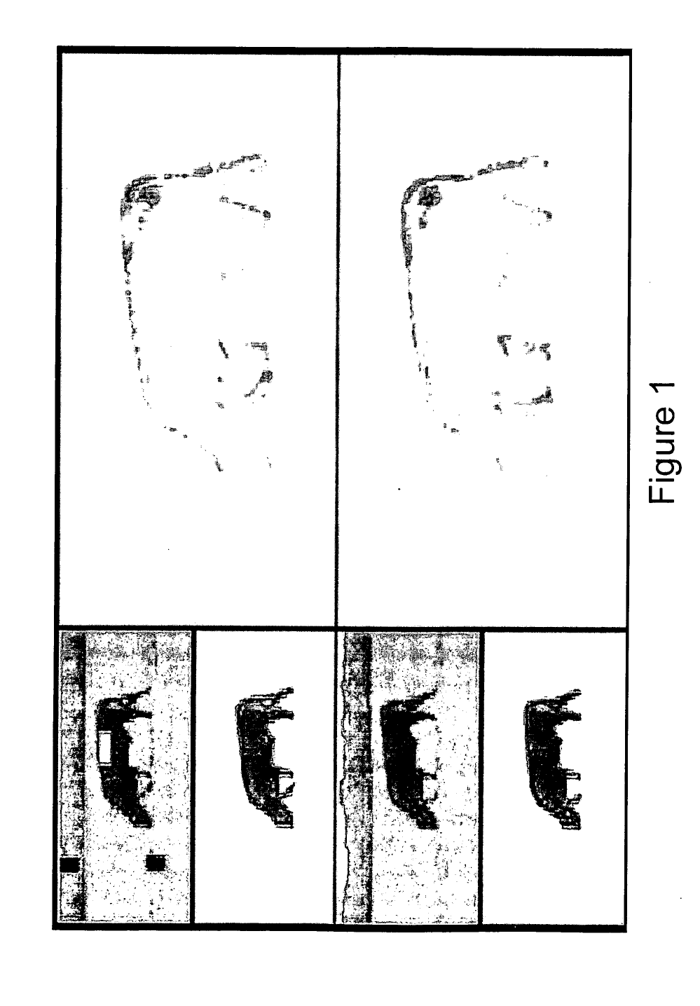

### DETAILED DESCRIPTION OF EMBODIMENT(S)

We present below a new fully dynamic algorithm for the st-mincut problem which allows for arbitrary changes in the graph. We show how this algorithm can be used to dynamically perform MAP inference in a MRF. Such an inference procedure is extremely fast and can be used in a number of problems.

In section 2, we discuss MRFs and show how they are used to model labelling problems like image segmentation and stereo, and how MAP estimates for MRFs can be found using graph cuts. In section 3, we provide the graph notation used in the paper, and formulate the st-mincut/maxflow problems. In section 4, we show how MAP solutions for dynamically changing MRFs can be efficiently found by updating data structures used for solving the max-flow problem. Specifically, we describe how we transform the residual graph to reflect the changes in the original graph, and discuss issues related to the computational complexity of the dynamic algorithm. In Section 5, we describe how we further optimize the process of recomputing the st-mincut/max-flow by reusing search trees. In section 6, we use the dynamic algorithm to perform image segmentation on video sequences, and compare its performance with that of the best-known st-mincut algorithm for graphs used in computer vision.

2. Markov Random Fields

Consider a set of random variables X={X₁, X₂, . . . , Xₙ} defined on the set S, such that, each variable Xᵢ can take a value xᵢ from the set L={l₁, l₂, . . . , lₙ} of all possible values. Then X is said to be a MRF with respect to a neighbourhood system N={Nᵢ|i ε S} if and only if it satisfies the positivity property P(x)>0, and markovian property
P(xᵢ|x_{s-{i}})=P(xᵢ|x_{N}_{ᵢ})∀iεS (1)

Here we refer to the joint event (X₁=x₁, . . . , Xₙ=xₙ) as X=x where x={xᵢ|iεS} is a configuration of F, corresponding to a realization of the field. We denote P(X=x) by P(x) and P(Xᵢ=xᵢ) by P(xᵢ).

The MAP-MRF estimation can be formulated as an energy minimization problem where the energy corresponding to the configuration x is the negative log likelihood of the joint posterior probability of the MRF given as
E(x)=−log P(x|D) (2)
2.1. MRFs for Image Segmentation

In the context of image segmentation, S corresponds to the set of all image pixels, N is a neighbourhood defined on this set, the set L comprises of labels representing the different image segments, and the random variables in the set X denote the labelling of the pixels in the image. Note that every configuration x of the MRF, defines a segmentation. The image segmentation problem can thus be solved by finding the least energy configuration of the MRF. The energy corresponding to a configuration x consists of a likelihood and a prior term as:

$${Ψ}_{1} ( x ) = {\sum }_{i ∈ S} ( ϕ ( D \vert {x}_{i} ) + {\sum }_{j ∈ {N}_{i}} ψ ( {x}_{i} , {x}_{j} ) ) \qquad ( 3 )$$

Note that for our experiments, we have used the standard 8-neighbourhood where φ(D|xᵢ) is the data log likelihood which imposes individual penalties for assigning label lᵢ to pixel i and is given by
φ(D|xᵢ) =−log p(iεSₖ|Hₖ) if xᵢ=lₖ (4)
where Hₖ is the RGB distribution for Sₖ, the segment denoted by label lₖ. The prior ψ(xᵢ,xⱼ) takes the form of a Generalized Potts model:

$$ψ ( {x}_{i} , {x}_{j} ) = \{ \begin{matrix}{K}_{ij} & if {x}_{i} \neq {x}_{j} \\ 0 & if {x}_{i} = {x}_{j}\end{matrix} \qquad ( 5 )$$

In MRFs used for image segmentation, a contrast term is added which favours pixels with similar colour having the same label [2]. This is incorporated in the energy function by reducing the cost within the Potts model for two labels being different in proportion to the difference in intensities of their corresponding pixels. For instance, for the experiments mentioned in section 6, we use the term

$$γ ( i , j ) = λ exp ( \frac{- {g}^{2} ( i , j )}{2 {σ}^{2}} ) \frac{1}{dist ( i , j )} \qquad ( 6 )$$

where g²(i, j) measures the difference in the RGB values of pixels i and j and dist(i, j) gives the spatial distance between i and j. This term can not be included in the prior, since the prior term cannot include the data, and hence has to be added separately. The energy function of the MRF now becomes

$${Ψ}_{2} ( x ) = {\sum }_{i ∈ S} ( ϕ ( D \vert {x}_{i} ) + {\sum }_{j ∈ {N}_{i}} ( ϕ ( D \vert {x}_{i} , {x}_{j} ) + ψ ( {x}_{i} , {x}_{j} ) ) ) \qquad ( 7 )$$

The contrast term of the energy function is defined as

$$ϕ ( D \vert {x}_{i} , {x}_{j} ) = \{ \begin{matrix}- γ ( i , j ) & if {x}_{i} \neq {x}_{j} \\ 0 & if {x}_{i} = {x}_{j}\end{matrix} \qquad ( 8 )$$

2.2. MRFs for Stereo

Consider two images A and B. In the stereo labelling problem, the label to be estimated for each site, or pixel p in the image A, is the disparity configuration xₚ which establishes the correspondence between the pixel p in image A and pixel q in image B. Here the label set L contains all possible disparities. The energy function for the MRFs used for this problem have the same form as (7). The likelihood term for this problem is an assignment cost from the intensity difference between pixels. Here too, the discontinuity preserving contrast term (6) is used to reduce the penalty for assigning different labels at the borders of objects.

2.3. Solving MRFs using Graph Cuts

The configuration x of the MRF having the least energy corresponds to the MAP solution of the MRF. The minimization of energies such as the one defined in (7) can be performed by computing the st-mincut on a graph [12, 5]. We now describe the equivalent graph construction for the two label case, for the multi-label case, the reader is referred to [12]. Each random variable Xᵢ of the MRF is represented by a vertex vᵢ in this graph, which is connected by edges to the vertices in its neighbourhood set defined as {vₖ|XₖεNᵢ}. We refer to these edges as n-edges. The cost of a n-edge (i, j) connecting vertices vᵢ and vⱼ is given by φ(D|xᵢ, xⱼ)+ψ(xᵢ, xⱼ).

The two labels lₓ and l_{y} are represented by special vertices called terminals namely, the source s and the sink t. They are connected to all other vertices representing the random variables in the MRF, by edges which we call t-edges. The cost of these t-edges is given by the likelihood term φ(D|xᵢ) of the energy function of the MRF. An st-cut in this graph which separates the source and the the sink, defines a configuration x of the MRF, and the cost of the cut is the energy of x [5]. Therefore, by finding the minimum cost cut we can find the MAP-solution of the MRF.

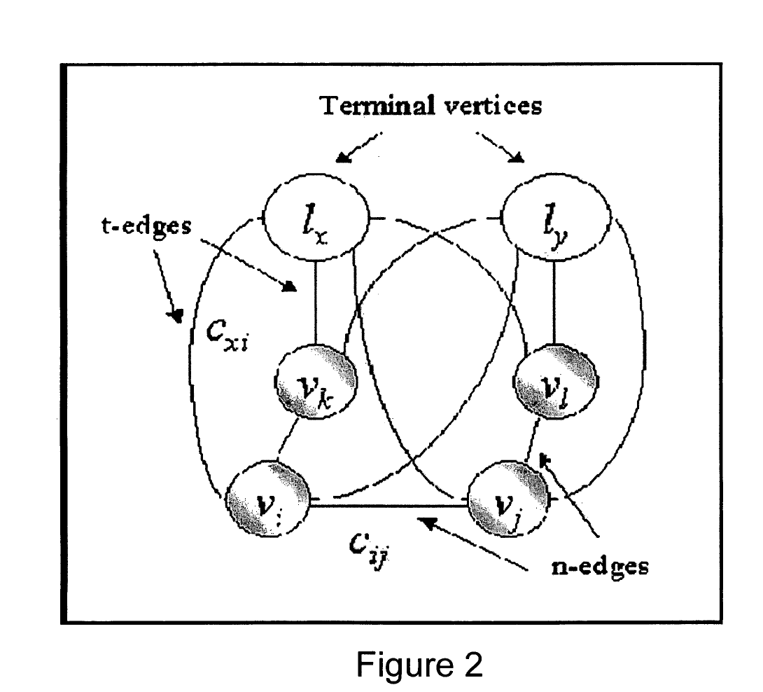

FIG. 2 is a graph representing an MRF with two labels lₓ and l_{y} and four random variables xᵢ, xⱼ, xₖ, and xₗ. The cost of the t-edge cₓᵢ is φ(D|xᵢ=lₓ) and the n-edge cᵢⱼ is φ(D|xᵢ, xⱼ)+ψ(xᵢ, xⱼ).

3. Notation and Problem Formulation

A directed weighted graph G(V, E, C) with non-negative edge weights, is defined by a set of nodes V, a set of directed edges E, and an edge cost function C defined as:
C:(i,j)→ [symbol] ⁺∀(i,j)εE (9)

Let n and m denote the number of nodes |V| and the number of edges |E| in the graph respectively. Graphs used in the st-mincut problem have certain special nodes called the terminal nodes, namely the source s, and the sink t. We classify the edges in the graph into two disjoint categories, t-edges which connect a node to a terminal node, and n-edges which connect nodes other than the terminal nodes with each other. We make the following assumptions in our notation: (i, j)εE [symbol] (j,i)εE, and
(s,i)εE and (i,t)εE ∀iεV

These assumptions are non-restrictive as edges with zero edge weights are allowed in our formulation. Thus we can conform to our notation without changing the problem.

Definition 1 A cut is a partition of the node set V into two parts S and \overline{S}=V−S, and is defined by the set of edges (i, j) such that iεS and jε\overline{S}. The cost of the cut

$$( S , \overline{S} ) is {C}_{S , \overline{S}} = {\sum }_{i ∈ S , , j ∈ \overline{S}} {c}_{ij} .$$

Definition 2 An st-cut is a cut satisfying the property that sεS and tε\overline{S}.

Given a directed weighted graph G, the st-mincut problem is to find a st-cut with the smallest cost. By the Ford-Fulkerson theorem [10], this is equivalent to computing the maximum flow from the source to sink with the capacity of each edge equal to its cost cᵢⱼ.

3.1. Formulating the Max-Flow Problem

For a capacitated network G(V, E) with a non-negative capacity cᵢⱼ associated with each edge, the max-flow problem is to find the maximum flow f from the source node s to the sink node t subject to the edge capacity and mass balance constraints given as:

$$\begin{matrix}{l}_{ij} \leq {f}_{ij} \leq {c}_{ij} and & ( 10 ) \\ {\sum }_{∀ i ∈ N ( x ) \backslash \{ s , t \}} ( {f}_{xi} - {f}_{ix} ) = {f}_{sx} - {f}_{xt} ∀ x ∈ V - \{ s , t ) & ( 11 )\end{matrix}$$

where fᵢⱼ is the flow from node i to node j, lᵢⱼ is the lower bound on the flow fᵢⱼ (which in our case is zero) and N(x) is the neighbourhood of x. Note that N(x) consists of all nodes connected by an edge to x.

Further, we note here that we can initialize the flows in the t-edges as fₛₓ=fₓₜ=min(cₛₓ,cₓₜ). This is analogous to pushing flow through the shortest augmenting path (defined later) from the source to the sink. The residual capacities of the terminal edges thus become:

$${r}_{sx} = {c}_{sx} - {f}_{sx} = \{ \begin{matrix}0 & if {c}_{sx} < {c}_{xt} \\ {c}_{sx} - {c}_{xt} & if {c}_{sx} > {c}_{xt}\end{matrix} and \\ {r}_{xt} = \{ \begin{matrix}0 & if {c}_{sx} > {c}_{xt} \\ {c}_{xt} - {c}_{sx} & if {c}_{sx} < {c}_{xt}\end{matrix}$$

We observe here, that the solution of the maximum flow problem is invariant to the absolute value of the terminal edge capacities cₛₓ and cₜₓ. It only depends on the difference of these capacities (cₓₜ−cₛₓ). Adding or subtracting a constant to these capacities changes the objective function by a constant and does not effect the overall solution. This property of the problem will be used later in the paper for updating the residual graph when the original graph has been modified.

3.2. Augmenting Paths and Residual Graphs

Definition 3 Given a flow fᵢⱼ, the residual capacity rᵢⱼ of an edge (i, j)εE is the maximum additional flow that can be sent from node i to node j using the edges (i, j) and (j, i).

Note that the residual capacity rᵢⱼ has two components

1. The unused capacity of the edge (i, j): cᵢⱼ−fᵢⱼ

2. The current flow fⱼᵢ through edge (j, i) which can be cancelled to increase the flow from i to j.

Definition 4 A residual graph G(f) of a weighted Graph G consists of the node set V and the edges with positive residual capacity (with respect to the flow f).

The topology of G(f) is identical to G. G(f) differs only in the capacity of its edges. For no flow i.e. f={0}, G(f) is same as G.

Definition 5 An augmenting path is a path from the source to the sink along unsaturated edges of the residual graph.

Algorithms for solving the max-flow problem can be classified into two general categories: Augmenting Path and Preflow-push algorithms. Augmenting path algorithms repeatedly find augmenting paths in the residual graph G(f) and push the maximum possible flow f′ through this path resulting in the total flow (f+f′) and the residual graph G(f+f′). Preflow-push algorithms flood the network and create excess flow at the graph nodes. This excess flow is then incrementally drained out by sending it from the node toward the sink or the source.

4. Estimating MAP solutions for Dynamic MRFs

Observe that the energy in equation (7) is dependent on the data defining the problem and changes from one problem instance to the next. A change in this energy results in the modification of edge costs in the graph used to the solve the MRF. Other changes in the MRF are similarly reflected in this equivalent graph. Instead of recomputing the st-mincut/max-flow in the graph from scratch, we dynamically update the flows obtained in the previous max-flow problem instance to make them consistent with the new edge capacities. Due to this process, we are able to preserve the flow from the source to the sink that is not affected by the change in the edge capacities (costs). After updating the flows and residual edge capacities, the max-flow algorithm is restarted on the residual graph.

Boykov et al. [3] in their work on interactive image segmentation, used this technique for efficiently recomputing the MAP solution when the likelihood term (4) changes (due to addition of new segmentation seeds by the user). However, their technique was restrictive and could only handle changes in the cost of t-edges of the graph. Our new method can handle arbitrary changes in the the graph. In our experiments, we used this approach to efficiently recompute the MAP solution for the image segmentation problem in videos. Note that a change of image, results in changes in both the likelihood and contrast terms of the energy function.

4.1. Updating Residual Graphs

While modifying the residual graph, certain flows may violate the new edge capacity constraints. We now show how we transform the residual graph to make such flows consistent. We address the problem of updating edge capacities for n-edges and t-edges separately.

4.1.1 Modifying n-Edge Capacities

We now discuss how we update the residual graph when n-edge capacities are changed. The reader should note here that this case was not addressed in [3]. We use cᵢⱼ′ to refer to the new edge capacity, and rᵢⱼ′ and fᵢⱼ′ to represent the updated residual capacity and flow respectively for the edge (i, j). We observe that updating edge capacities in the residual graph is trivial if the new edge capacity cᵢⱼ′ is greater than or equal to the old edge capacity cᵢⱼ (this operation involves addition of extra capacity and thus the flow cannot become inconsistent). The updated residual capacity r′ᵢⱼ becomes:
rᵢⱼ′=rᵢⱼ+(cᵢⱼ′−cᵢⱼ) (12)

Even if cᵢⱼ′ is less than cᵢⱼ, the procedure still remains trivial if the flow fᵢⱼ is less than the new edge capacity Cᵢⱼ′. This is due to the fact that the reduction in the edge capacity does not affect the flow consistency of the network i.e flow fᵢⱼ satisfies the edge capacity constraint (10) for the new edge capacity. The residual capacity of the edge can still be updated according to equation (12). The difference in this case will be that (cᵢⱼ′−cᵢⱼ) is negative and hence will result in the reduction of the residual capacity. In both these cases the flow through the edge is unchanged i.e. fᵢⱼ′=fᵢⱼ.

The problem ceases to remain trivial in the case when the new edge capacity cᵢⱼ′ is less than the flow fᵢⱼ. In this case, fᵢⱼ violates the edge capacity constraint (10). To make fᵢⱼ consistent, we have to retract the excess flow (fᵢⱼ−cᵢⱼ′) from the edge (i, j). At this point, the reader should note that a trivial solution for this operation would be to push back the flow through the augmenting path it originally came through. However such an operation would be extremely computationally expensive.

We now show how we resolve this in constant i.e. O(l) time. We set the updated flow (fᵢⱼ′=cᵢⱼ′). This change in the flow value changes the residual capacities of the edges (i, j) and (j, i) as: rᵢⱼ′=cᵢⱼ′−fᵢⱼⁱ and rⱼᵢ′=cⱼᵢ+fᵢⱼ′. Further, the change in the flow through edge (i, j) creates a surplus sᵢ of flow at node i and a deficiency dⱼ at node j, which violate the mass balance constraints (11) for node i and node j where
sᵢ=dⱼ=fᵢⱼ−fᵢⱼ′=fᵢⱼ−cᵢⱼ′.
Satisfying the Mass Balance Constraints

The mass balance constraint for node i after updating the flows becomes

$${\sum }_{∀ y ∈ N ( i ) \backslash \{ s , t \}} ( {f}_{iy}^{′} - {f}_{yi}^{′} ) = {f}_{si}^{′} - {f}_{it}^{′} \qquad ( 13 )$$

Keeping flow of all n-edges other than the edge (i, j) the same i.e.

f_{xy}′=f_{xy}, ∀(x,y)εE\(i, j) and subtracting equation (13) from (11) we get fₛᵢ′−fᵢₜ′=fₛᵢ−fᵢₜ−sᵢ. Setting fₛᵢ′=fₛᵢ, it becomes fᵢₜ′=fᵢₜ+sᵢ. Similarly, for node j, we get fₛⱼ′=fₛⱼ+dⱼ. We now consider the mass balance constraint of node i (for node j, the process will be similar). The new value of the flow from node i to the sink node t, fᵢₜ′ it satisfies the mass balance constraint for node i and in effect solves our problem. However, a problem arises if this new value of flow violates the edge capacity constraints for the edge (i, t) i.e. fᵢₜ′>cᵢₜ. To overcome this problem we add a constant α to the capacities of both the edges (i, t) and (s, i) to get cᵢₜ′ and cₛᵢ′ respectively where
α=max{0,fᵢₜ′−cᵢₜ}
or, α=max{0,(fᵢₜ+sᵢ)−cᵢₜ}
or, α=max{0,sᵢ−rᵢₜ}.

This transformation changes the objective function value by a constant and hence, doesn't change the optimal solution (this transformation results in the addition of flow a flowing from the source to the sink). This constant can be recorded separately and ignored while solving the problem. The residual capacities of these edges now become
rₛᵢ′=(cₛᵢ+α)−fₛᵢ′ (14)
and rᵢₜ′=(cᵢₜ+α)−fᵢₜ′ (15)

On substituting the value of α in (14,15) and simplifying, we get:

$${r}_{si}^{′} = \{ \begin{matrix} {r}_{si} - {r}_{it} + {s}_{i} \\ {r}_{si}\end{matrix} \begin{matrix}if α = 0 \\ otherwise .\end{matrix}$$

$$and {r}_{it}^{′} = \{ \begin{matrix}0 & if α = 0 \\ {r}_{it} - {s}_{i} & otherwise .\end{matrix}$$

Similarly, for node j, we get

$${r}_{jt}^{′} = \{ \begin{matrix}{r}_{jt} - {r}_{sj} + {d}_{j} & if β = 0 \\ {r}_{jt} & otherwise .\end{matrix}$$

$$and {r}_{sj}^{′} = \{ \begin{matrix}0 & if β = 0 \\ {r}_{sj} - {d}_{j} & otherwise .\end{matrix}$$

where β=max {0, fₛⱼ′−cₛⱼ}. To summarize, the following steps update the residual graph in the case when the updated edge capacity cᵢⱼ′ is less than the flow fᵢⱼ.
Sᵢ=dⱼ=(ƒᵢⱼ−c′ᵢⱼ)
r′ᵢⱼ=0
ƒ′ᵢⱼ=c′ᵢⱼ
r′ⱼᵢ=c′ⱼᵢ+ƒ′ᵢⱼ
if(ƒ′ᵢₜ−cᵢₜ>0)
r′ᵢₜ=rᵢₜ−sᵢ
else
r′ᵢₜ=0
r′ₛᵢ=rₛᵢ−rᵢₜ+sᵢ
endif
if(ƒ′ₛⱼ−cₛⱼ>0)
r′ₛⱼ=rₛⱼ−dⱼ
else
r′ₛⱼ=0
r′ⱼₜ=rⱼₜ−rₛⱼ+dⱼ
endif
4.1.2 Modifying t-Edge Capacities

Our technique for updating terminal edges is similar to the one used in [3]. We skip the trivial cases where the flow fₛᵢ is less than the updated edge capacity cₛᵢ′, and directly address the case where the flow is greater than the updated edge capacity and hence violate the edge capacity constraint (10). For making the flow consistent, we add a constant γ=fₛᵢ−cₛᵢ′ to both the t-edges connected to the node i. Such a change does not affect the solution of the st-mincut problem as explained earlier. The residual capacities thus become: rₛᵢ′=cₛᵢ−fₛᵢ+γ=0
and rᵢₜ′=cᵢₜ−fᵢₜ+γ=rᵢₜ+cₛᵢ′−fₛᵢ.
4.2. Complexity Analysis of Update Operations

Modifying an edge cost in the residual graph takes O(l) time. Arbitrary changes in the graph like addition or deletion of nodes and edges can be expressed in terms of the modifying an edge cost. The time complexity of all such changes is O(l) except for deleting a node, where the update time is O(k), where k is degree of the node to be deleted. The capacity of all edges incident on the node has to be made zero, which takes O(l) time per edge.

After the residual graph has been updated to reflect the changes in the MRF, we start the generic augmenting path procedure for finding the maximum flow. This involves repeatedly finding augmenting paths in the residual graph and saturating them. When no more augmenting paths can be found i.e. the source and sink are disconnected in the residual graph, we reach the maximum flow.

The maximum flow from the source to the sink is a loose upper bound on the number of augmenting paths founds by the augmenting path procedure. Also, the total change in edge capacity bounds the increase in the flow ∇f defined as:

$$∇ f \leq {\sum }_{i = 1}^{{m}^{′}} \vert {c}_{{e}_{i}}^{′} - {c}_{{e}_{i}} \vert ,$$

where eᵢεE or, ∇f≦m′cₘₐₓ where cₘₐₓ=max(|cₑ_{ᵢ}′−cₑ_{ᵢ}|). Thus we get a trivial O(m′cₘₐₓ) bound on the number of augmentations, where m′ is the number of edge capacity updates. The best augmenting path algorithms have a upper-bound of O(nm) on the number of augmentations. In dynamic problems, like video segmentation where m′cₘₐₓ<<nm, a dynamic algorithm has a better upper bound.
5. Optimizing the Algorithm

We have already seen how by dynamically updating the residual graph, we can reduce the time taken to compute the st-mincut. We can further improve the running time by using a technique motivated by the augmenting path based algorithm proposed in [4] for solving the st-mincut/max-flow problem. Typical augmenting path based methods start a new breadth-first search for (source to sink) paths as soon as all paths of a given length are exhausted. For instance, Dinic [9] proposed an augmenting path algorithm which builds search trees to find augmenting paths. This is a computationally expensive operation, as it involves visiting almost all nodes of the graph, and makes the algorithm slow if it has to be performed too often. To counter this, Boykov and Kolmogorov [4] proposed an algorithm in which they re-used the search tree. In their experiments, this new algorithm outperformed the best-known augmenting-path and push-relabel algorithms on graphs commonly used in computer vision.

In our dynamic max-flow algorithm, we reuse the search tree available from the previous max-flow computation to find the solution in the updated residual graph. This technique saves us the cost of creating a new search tree, thus making our algorithm substantially faster. We next describe how the algorithm in [4] works and how we recycle the search trees and use them.

5.1. Reusing Search Trees

The algorithm maintains two non-overlapping search trees S and T with roots at the source s and the sink t respectively. In tree S all edges from each parent node to its children are unsaturated, while in tree T edges from children to their parents are non-saturated. The nodes that are not in S or Tare called free. The nodes in the search trees S and T can be either active (can grow by acquiring new children along non-saturated edges) or passive. When an active node comes in contact with a node from the other tree, an augmenting path is found. The algorithm has three basic stages:

a) Growth Stage: The search trees S and T are grown until they touch resulting in an augmenting path. The active nodes explore adjacent non-saturated edges and acquire new children from the set of free nodes, which now become active. As soon as all neighbours of a given active node are explored the active node becomes passive.

b) Augmentation Stage: Flow is pushed through the path found in the growth stage. This results in some nodes of the trees S and T becoming orphans since the edges linking them to their parents become saturated. Note that this breaks the source and sink search trees into forests.

c) Adoption Stage: The search trees are then restored by finding a new valid parent (of the same set, through a non-saturated edge) for each orphan. If no qualifying parent can be found, the node is made free. While dynamically updating the residual graph, certain edges of the trees S and T may become saturated. These edges have to be deleted breaking the trees into forests and making certain nodes orphans. We keep track of all the orphaned nodes and before recomputing the st-mincut on the modified residual graph, we restore the trees by finding a new valid parent for every node. This process is similar to the adoption stage and works as follows:

d) Tree Restoration Stage: The aim of the tree restoration stage is two fold. First, to find parents for orphaned nodes, and secondly (but more importantly) to make sure that the length of the path from the root node to all other nodes in the tree is as small as possible. This is needed to reduce the time spent at passing flow through an augmenting path. Note that a longer augmenting path would lead to a slower algorithm. This is because the time taken to update the residual capacities of the edges constituting the augmenting path during the augmentation stage would be high.

The first objective of the restoration stage can be met by using the adoption stage alone. For the second objective, we do the following: For each graph node i which has been affected by the graph updates, we check the residual capacities of its t-edges ((s,i) or (i,t)). Suppose node i belonged to the source tree before the updates.

Case 1: If (rₛᵢ>rᵢₜ) we change the parent of the node to the terminal node ‘source’ (s).

Case 2: If (rₛᵢ<rᵢₜ) we change the parent of the node to the terminal node ‘sink’ (t). This means that the node has now become a member of sink tree T. All the immediate child nodes of i are then made orphans.

Case 3: If (rₛᵢ=rᵢₜ) we leave the node as it is.

6. Experimental Analysis

We now demonstrate our method on the object-background segmentation problem and analyze its performance.

6.1. Fast Image Segmentation in Videos

The object-background segmentation problem aims to segment out the objects in an image so that they can be pasted in a different context. In our case, this process has to be performed over all frames in the video sequence. We formulate the problem as follows.

The user specifies hard and soft constraints on the segmentation by providing segmentation cues or seeds. The soft constraints are used to build colour histograms for the object and background, which are used for calculating the likelihood term φ(D|fᵢ) of the energy function (7) of the MRF. The hard constraints consists of strict pixel label values which have to be maintained through all the frames of the video. These constraints are used for specifying pixel positions which are guaranteed to have the same label (object or background) throughout the video sequence and do not contribute to the colour histograms.

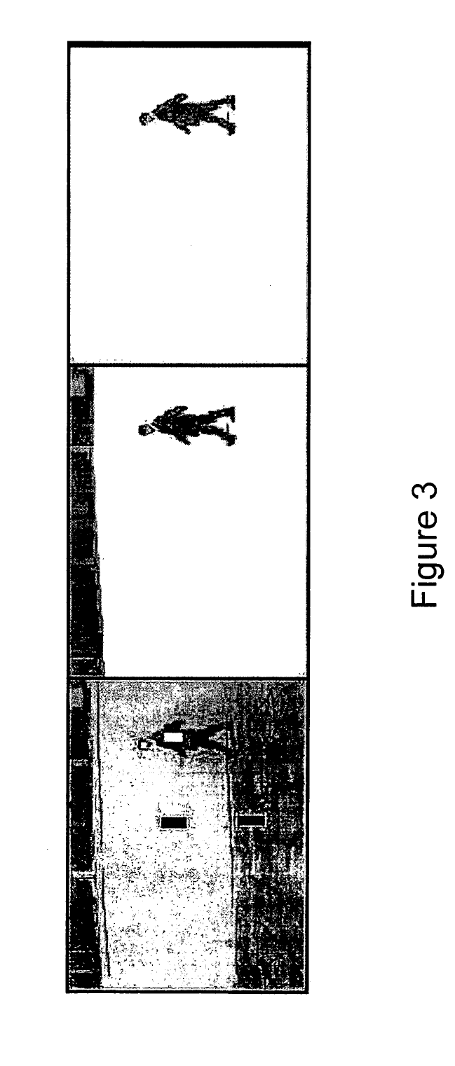

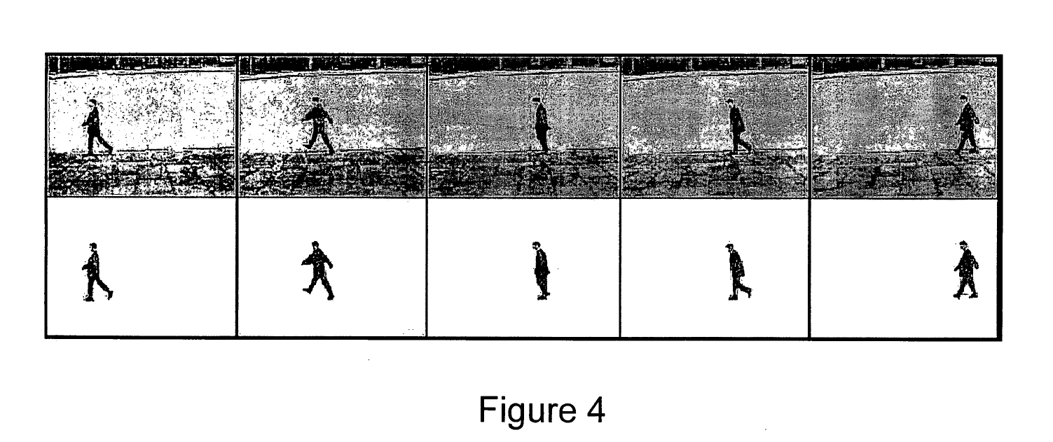

We impose the hard constraints on the segmentation by incorporating them in the likelihood term φ(D|fᵢ). This is done by setting a very high cost for a label assignment that violates the hard constraints. FIG. 3 demonstrates the use of constraints in the image segmentation process. The first image is the input showing the soft constraints represented by black (background) and white (foreground) rectangles. The second image shows the segmentation obtained using the soft constraints, which contains a certain portion of the background wrongly marked as the foreground due to similar colour intensity. The third image is the segmentation result obtained by using a hard constraint on the area along with the soft constraints. The segmentation results are shown in FIG. 4.

6.2. Performance Evaluation

We tested the dynamic graph cut algorithm on a number of video sequences and compared its performance with the dual-search tree algorithm proposed in [4], which has been experimentally shown to be the fastest for several vision problems including image segmentation. In our results, we refer this algorithm as static since it starts afresh for each problem instance.

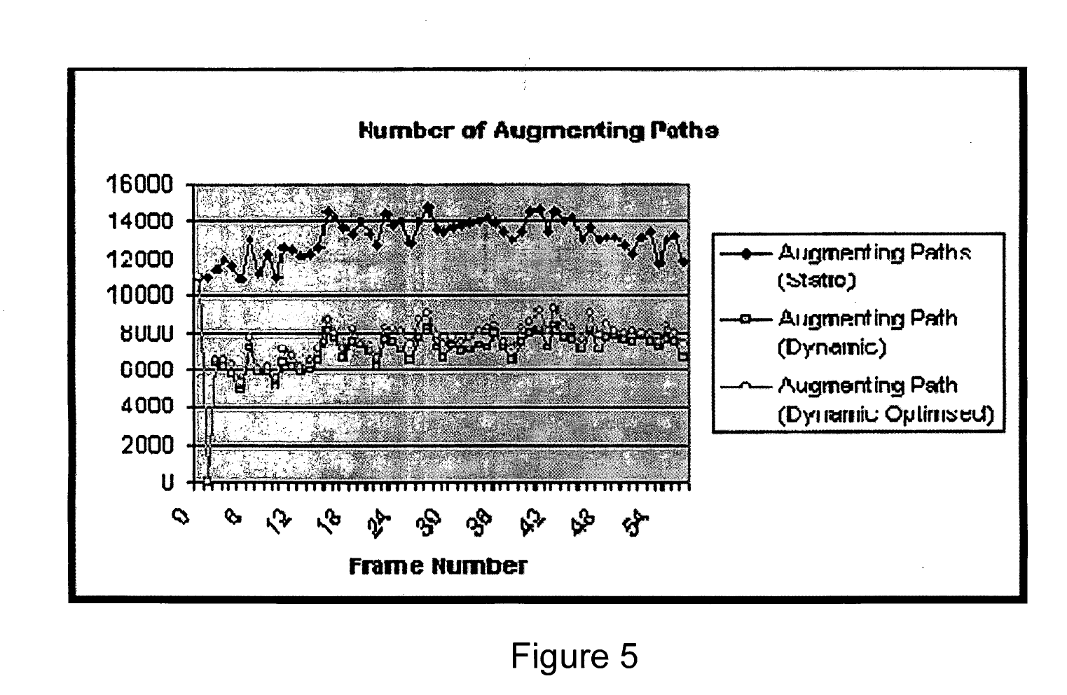

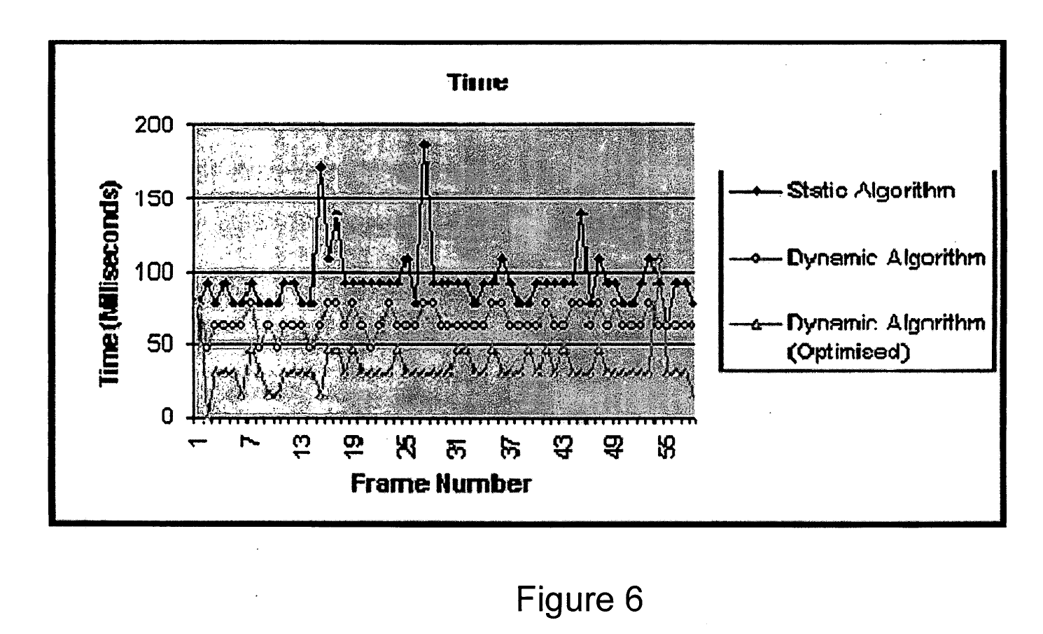

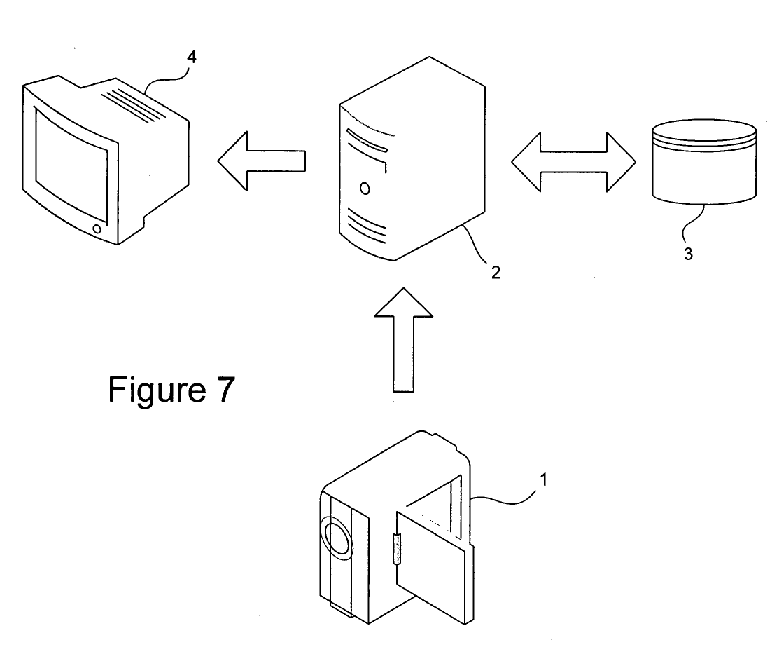

The video sequences used in our tests had between one hundred to a thousand image frames. In all the sequences, dynamically updating the residual graph produced a substantial decrease in the number of augmenting paths. The running times of the dynamic algorithm (normal and optimized) were substantially less than the time of the static algorithm. The average running times for the static, dynamic and optimized dynamic algorithms for the human lame walk sequence of size (368×256) were 91.4, 66.0, and 33.6 milliseconds and for the grazing cow sequence of size (720×578) were 188.8, 151.3, 78.0 millisecond respectively. The experiments were done on a Pentium 4 2.8 GHz machine. The graphs in FIGS. 5 and 6 show the performance of the algorithms on the first sixty frames of the human lame walk sequence. FIG. 5 shows the number of augmenting paths found by the algorithms and FIG. 6 shows the running time of the algorithms. Note that the first and second frames of the video sequence are the same, and hence the residual graph does not need to be updated. This results in zero augmenting paths found by the dynamic algorithms when segmenting frame 2. Observe that the number of augmenting paths found is least in the case of the dynamic (un-optimized) algorithm, followed by the optimized and static algorithm. The difference in the number of augmenting paths found in the normal and optimized versions is due to the use of recycled search trees in the optimized algorithm.

7 Apparatus

FIG. 7 illustrates in schematic form, apparatus for performing the algorithm described above. An image capture device 1 (such as a still or video camera) generates an image (or a series of images in the case of video) which are input to a computer processor 2. The computer processor is connected to a memory 3 storing software for implementing the algorithm. The processor 2 generates outputs (such as the segmentation results shown in FIG. 4) which are displayed on a screen 4.

8. Conclusion

In summary, we have presented a fast new ‘fully’ dynamic graph algorithm for the st-mincut/max-flow problem. We have shown how this algorithm can be used to efficiently compute MAP estimates for dynamically changing MRF models of labelling problems in computer vision, such as image segmentation, and stereo. Specifically, we have shown how to adjust the data structures used for the solution of the previous max-flow problem instance, to reflect the changes in the problem and then, how to use them to rapidly compute the solution in the new instance. We chose to demonstrate our algorithm on one particular problem: the object-background segmentation problem for video and compare its performance with the best known minimum cut algorithm. The results show that the dynamic graph cut algorithm is much faster than its static counterpart and enables real time image segmentation. It should be noted that the method is generic, and we expect it to yield similar improvements in many other problem areas that involve dynamic change.

The results show that our method is substantially faster, and enables real time image segmentation in video sequences.

Although the invention has been described above with reference to one or more preferred embodiments, it will be appreciated that various changes or modifications may be made without departing from the scope of the invention as defined in the appended claims

### REFERENCES

[1] R. Ahuja, T. Magnanti, and J. Orlin. Network Flows. Prentice Hall, Englewood Cliffs, N.J., 1993.
[2] A. Blake, C. Rother, M. Brown, P. Perez, and P. Torr. Interactive image segmentation using an adaptive gmmrf model. In ECCV04, pages Vol I: 428-441, 2004.
[3] Y. Boykov and M. Jolly. Interactive graph cuts for optimal boundary and region segmentation of objects in n-d images. In ICCV01, pages 1: 105-112, 2001.
[4] Y. Boykov and V. Kolmogorov. An experimental comparison of min-cut/max-flow algorithms for energy minimization in vision. PAMI, 26(9): 1124-1137, September 2004.
[5] Y. Boykov, O. Veksler, and R. Zabih. Markov random fields with efficient approximations. In CVPR98, pages 648-655, 1998.
[6] Y. Boykov, O. Veksler, and R. Zabih. Fast approximate energy minimization via graph cuts. In ICCV99, pages I: 377-384, 1999.
[7] Y.-J. Chiang and R. Tamassia. Dynamic algorithms in computational geometry. Technical Report CS-91-24, 1991.
[8] R. F. Cohen and R. Tamassia. Dynamic expression trees and their applications. In SODA91, pages 52-61, 1991.
[9] E. A. Dinic. Algorithm for solution of a problem of maximum flow in networks with power estimation. Soviet Math. Dokl., 11: 1277-1280, 1970.
[10] L. Ford and D. Fulkerson. Flows in Networks. Princeton University Press, Princeton, 1962.
[11] D. Greig, B. Porteous, and A. Seheult. Exact maximum a posterori estimation for binary images. RoyalStat, B: 51(2):271-279, 1989.
[12] H. Ishikawa. Exact optimization for markov random fields with convex priors. PAMI, 25(10):1333-1336, October 2003.
[13] V. Kolmogorov and R. Zabih. What energy functions can be minimized via graph cuts? In ECCV02, page III: 65 ff., 2002.
[14] M. Thorup. Fully-dynamic min-cut. In STOC '01: Proceedings of the thirty-third annual ACM symposium on Theory of computing, pages 224-230. ACM Press, 2001.

1. A method of labelling image pixels, the method comprising:
a. constructing a graph representative of an image, the graph comprising a set of nodes each representative of one of the image pixels; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals;
e. changing the capacity assigned to at least one of the N-links and at least one of the T-links in response to a change in the image; and
f. dynamically updating the first minimum cut/maximum flow solution determined in step d. to take into account the changed capacities.

2. A method according to claim 1 wherein the first minimum cut/maximum flow solution is determined in step d. by generating a residual graph from the graph, and performing an augmenting path algorithm on the residual graph.

3. A method according to claim 2 wherein the first minimum cut/maximum flow solution is updated in step f. by updating the residual graph generated in step d. to take into account the changed capacities, and performing the augmenting path algorithm on the updated residual graph.

4. A method according to claim 3 wherein the augmenting path algorithm generates at least one search tree in step d., and wherein the search tree is reused in step f.

5. A method according to claim 1 wherein the image pixels are pixels in a video sequence.

6. A method according to claim 1, further comprising performing image segmentation in accordance with the minimum cut/maximum flow solutions.

7. A method according to claim 1, further comprising modifying the image in accordance with the minimum cut/maximum flow solutions.

8. Apparatus configured to perform the method of claim 1.

9. A memory storing computer software configured to implement the method of claim 1.

10. A method of labelling image pixels, the method comprising:
a. constructing a graph representative of an image, the graph comprising a set of nodes each representative of one of the image pixels; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals, the first solution being determined by:
iii. generating a residual graph from the graph, and
iv. performing an augmenting path algorithm on the residual graph, the augmenting path algorithm generating at least one search tree;
e. changing the capacity assigned to at least one of the N-links or at least one of the T-links in response to a change in the image; and
f. dynamically updating the first minimum cut/maximum flow solution determined in step d. to take into account the changed capacity, the first solution being updated by:
iii. updating the residual graph generated in step di., and
iv. performing the augmenting path algorithm on the updated residual graph, the augmenting path algorithm reusing the search tree generated in step dii.

11. A method according to claim 10 wherein the image pixels are pixels in a video sequence.

12. A method according to claim 10, further comprising performing image segmentation in accordance with the minimum cut/maximum flow solutions.

13. A method according to claim 10, further comprising modifying the image in accordance with the minimum cut/maximum flow solutions.

14. Apparatus configured to perform the method of claim 10.

15. A memory storing computer software configured to implement the method of claim 10.

16. A method of solving an energy minimization problem, the method comprising:
a. constructing a graph representative comprising a set of nodes; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals;
e. changing the capacity assigned to at least one of the N-links and at least one of the T-links in response to a change in the problem; and
f. dynamically updating the first minimum cut/maximum flow solution determined in step d. to take into account the changed capacities.

17. Apparatus configured to perform the method of claim 16.

18. A memory storing computer software configured to implement the method of claim 16.

19. A method of solving an energy minimization problem, the method comprising:
a. constructing a graph representative comprising a set of nodes; two terminals; a set of N-links each connecting a pair of the nodes; and a set of T-links each connecting one of the terminals with one of the nodes;
b. assigning a capacity to each of the N-links;
c. assigning a capacity to each of the T-links;
d. determining a first minimum cut/maximum flow solution which partitions the nodes into subsets, each subset containing one of the terminals, the first solution being determined by:
v. generating a residual graph from the graph, and
vi. performing an augmenting path algorithm on the residual graph, the augmenting path algorithm generating at least one search tree;
e. changing the capacity assigned to at least one of the N-links or at least one of the T-links in response to a change in the problem; and
f. dynamically updating the first minimum cut/maximum flow solution determined in step d. to take into account the changed capacity, the first solution being updated by:
v. updating the residual graph generated in step di., and
vi. performing the augmenting path algorithm on the updated residual graph, the augmenting path algorithm reusing the search tree generated in step dii.

20. Apparatus configured to perform the method of claim 19.

21. A memory storing computer software configured to implement the method of claim 20.
